(19) United States
(12) Patent Application Publication
(10) Pub. No.: US 2014/0182021 A1
(43) Pub. Date: Jun. 26, 2014

(54) A MICRODEVICE FOR EMITTING ELECTROMAGNETIC RADIATION

(71) Applicants: Jesper Glückstad, Frederiksberg (DK); Darwin Palima, Soborg (DK)

(72) Inventors: Jesper Glückstad, Frederiksberg (DK); Darwin Palima, Soborg (DK)

(73) Assignee: DANMARKS TEKNISKE UNIVERSITET, Lyngby (DK)

(21) Appl. No.: 14/115,826

(22) PCT Filed: May 16, 2012
(86) PCT No.: PCT/DK2012/050173

§ 371 Date: Jan. 20, 2014

Related U.S. Application Data
(60) Provisional application No. 61/486,541, filed on May 16, 2011.
(60) Provisional application No. 61/581,276, filed on Dec. 29, 2011.

(30) Foreign Application Priority Data
May 16, 2011 (EP) 11166161.7
Dec. 29, 2011 (EP) 11196097.7

(51) Int. Cl. G01Q 60/22

(52) U.S. Cl. CPC G01Q 60/22
USPC 850/32

(57) ABSTRACT

The present invention relates to a microdevice for emitting electromagnetic radiation, the microdevice being adapted so as to be controllable by electromagnetic radiation, such as light. The microdevice comprises a first electromagnetic radiation emitting unit arranged to emit electromagnetic radiation 1728, so as to be able to irradiate electromagnetic radiation onto a structure of interest 1740. The microdevice further comprising means for enabling non-contact spatial control over the microdevice in terms of translational movement in three dimensions, and rotational movement around at least two axes. The present invention thus provides an instrument which enables controlled irradiation of light onto very well defined areas on the nano-scale of objects of interest. Furthermore, the device enables receipt of light and may thus work as an optically controlled microendoscope.

### CROSS REFERENCE TO RELATED APPLICATIONS

This application is a U.S. National Phase Application of PCT International Application Number PCT/DK2012/050173, filed on May 16, 2012, designating the United States of America and published in the English language, which is an International Application of and claims the benefit of priority to European Patent Application No. 11166161.7, filed on May 16, 2011, U.S. Provisional Application No. 61/486,541, filed on May 16, 2011, European Patent Application No. 11196097.7, filed on Dec. 29, 2011 and U.S. Provisional Application No. 61/581,276, filed on Dec. 29, 2011. The disclosures of the above-referenced applications are hereby expressly incorporated by reference in their entireties.

### FIELD OF THE INVENTION

The present invention relates to a device for investigating or analyzing an associated object, and more specifically to a device and a method for facilitating investigating or analyzing an associated object with electromagnetic radiation.

### BACKGROUND OF THE INVENTION

Within the field of investigation or analyzing objects with electromagnetic radiation it is of constant appeal to be able to improve the instruments used to gain information about the examined objects. For example, it is a desire to improve the spatial resolution. Another desire is to expand the types of objects which can be examined.

The field has spawned a large number of techniques which each have contributed to the general progress of the field. Examples include confocal microscopy and scanning near field optical microscopy. An example of a reference which provides good spatial resolution and which enables scanning of objects is given by the application US2009/0276923 which describes models of optical fibers with end-faces containing sharp linear edges and randomly distributed nanoparticles. These probes are more robust than the conventional probes and their fabrication is not concerned with nanoscale precision. The probes enable waveguiding of light to and from the sample with marginal losses distributing and utilizing the incident light more completely. Regardless of the progress made there still exists a desire in the field to be able to simplify the equipment used and to examine objects which are not fixated on a surface.

WO 2006/008550 A1 describes a device for manipulation by a plurality of optical traps is disclosed. Connected trapping elements such as transparent beads are also connected to a tip, which is spaced from the trapping elements by a distance greater than the effective range of the optical trapping fields.

WO 03/018299 A1 describes micrometer and nanometer-sized tools, referred to as MOTS and NOTS, respectively, are manipulated in the illumination of an optical trap and are able to alter the physical, chemical or electronic structure or orientation of a workpiece.

Hence, an improved device and method for investigating or analyzing an associated object with electromagnetic radiation would be advantageous, and in particular a more efficient, reliable, simple device and method would be advantageous, and more particularly a device enabling analysis of objects which are not fixated on surfaces.

### SUMMARY OF THE INVENTION

It is a further object of the present invention to provide an alternative to the prior art.

In particular, it may be seen as an object of the present invention to provide a microdevice that solves the above mentioned problems of the prior art with providing a more efficient, reliable, simple device and method, and more particularly a device enabling analysis of objects which are not fixated on surfaces.

Thus, the above described object and several other objects are intended to be obtained in a first aspect of the invention by providing a microdevice for emitting EMR, the microdevice comprising
a first EMR emitting unit arranged to emit EMR,
means for enabling simultaneous non-contact spatial control over the microdevice in terms of:
   translational movement in three dimensions, and
   rotational movement around at least two axes,
      wherein the means for enabling non-contact spatial control over the microdevice are arranged for being spatially controlled by forces applied by EMR, and wherein the first EMR emitting unit and the means for enabling spatial control over the microdevice are structurally linked.

The invention is particularly, but not exclusively, advantageous for analyzing objects using well-known technology and equipment such as optical tweezers, and furthermore enables probing using a microdevice which may have a size on the same length scale as, e.g., mammalian cells. Furthermore, since the microdevice may be suspended in a liquid and spatially controlled, it may be used for probing other objects which are suspended in the liquid, such as mammalian cells. The invention effectively enables a manoeuvrable and versatile subwavelength light source that, in principle, is limited only by the available light sources themselves. The present invention thus addresses the need for a tuneable light source and the challenge of real-time, optical actuation of nanotools. It provides a practical alternative to developing a tuneable subwavelength light source (e.g. using inorganic nanowires) by shifting the tunability and other engineering requirements to more manageable macroscopic laser systems.

Other advantages of particular embodiments of the invention are outlined in the following section. Bringing photonics tools into the nanoscale is typically challenged by the classical diffraction barrier. Overcoming the diffraction challenge for imaging entails either using near-field approaches or far-field optics that exploits nonlinear optical processes. Beyond imaging, photonics can also leverage nanoscopic activation, probing and manipulation. For example, an optically trapped nanowire working as tuneable light source can work as a versatile optical probe. The invention solves, in particular embodiments, the problem of providing a subwavelength source having the tuneability of advanced laser systems, which can be manoeuvred in the nanoscale. The invention proposes, in a particular embodiment, a novel approach using structure-mediated micro-to-nano coupling. The present applications suggests in particular embodiments, a microdevice that channels optical force and optical energy from far-field optics into the subwavelength domain. The microdevice, which may be fabricated by two-photon photopolymerization (2PP), can couple mechanical force from the optically trapped handles to achieve up to six degree-of-freedom (6DOF) control over a nanotool. This microdevice can also channel arbitrary light sources into its sub-diffraction limit tip. Handling these microdevices using, e.g, a BioPhotonics Workstation enables real-time 6DOF nanotool control and targeted light delivery. This sets the stage for calibrated steering of functionalized nanotools and effectively creates a versatile subwavelength light source, limited only by available light sources themselves. This opens new avenues for far-field optics in subwavelength photonics and its wide ranging applications in the natural sciences.

‘Electromagnetic radiation’ (EMR) is well-known in the art. EMR is understood to include various types of electromagnetic variation, such as various types corresponding to different wavelength ranges, such as radio waves, microwaves, infrared radiation, EMR in the visible region (which humans perceive or see as ‘light’), ultraviolet radiation, X-rays and gamma rays. The term optical is to be understood as relating to light. EMR is also understood to include radiation from various sources, such as incandescent lamps, LASERs and antennas. It is commonly known in the art, that EMR may be quantized in the form of elementary particles known as photons. In the present application, the terms ‘light’ and ‘optical’ is used for exemplary purposes. It is understood, that where ‘light’ or ‘optical’ is used it is only used as an example of EMR, and the invention is understood to be applicable to also other wavelength intervals where reference is made to ‘light’ or ‘optical’.

By ‘microdevice’ is understood is understood a device on the scale of micrometres, such as a device having length, width and height within a range from 1 micrometre to 1 millimetre.

By ‘EMR unit’ is understood a unit which is capable of emitting EMR. The EMR may redirect EMR which is received by the EMR unit, such as the EMR unit being a mirror or a lens, or the EMR unit may comprise an emitter capable of generating the EMR which the EMR unit emits.

By ‘means for enabling simultaneous non-contact spatial control’ is understood physical features which enable electromagnetic

By ‘translational movement’ is understood movement where the microdevice is moved from a first position in space to a second position in space. It is understood that there are three spatial dimensions (corresponding to three axis—x, y, and z—in a Cartesian coordinate system), and translational movement in three dimensions thus corresponds to enabling movement in all directions.

By ‘rotational movement’ is understood movement where the microdevice is rotated—a certain angle—around its own centre of gravity. It is understood that there are three spatial dimensions (corresponding to three axis—x, y, and z—in a Cartesian coordinate system), and rotational movement in three dimensions thus corresponds to enabling movement around all axes. Control over rotational movement of a device around at least two axes means that the rotation of the device around 2 axes is controlled, while rotation of the device around the last axis is not necessarily controlled.

Means for enabling simultaneous non-contact spatial control over the microdevice in terms of translational movement in three dimensions, and rotational movement around at least two axes may alternatively be formulated as means for enabling simultaneous control over 3 translational degrees of freedom and 2 rotational degrees of freedom, i.e., a total of 5 degrees of freedom. This may be advantageous since it allows placing the microdevice in any position and any orientation. For example, the microdevice may be moved around a human cell while always being oriented toward the centre of the cell, such as having the EMR emitting unit pointing toward the centre of the cell. In particular embodiments, said means may be embodied in the form of EMR controllable handles, such as optical handles.

In one particular embodiment, the microdevice features functionalization, where ‘functionalization’ is understood to be an element which enables the device to carry out a function in relation to an associated element. Examples of functionalization may include coating a part of the microdevice with functional biological molecules such as enzymes, nucleic acid strands (e.g., DNA or RNA), which provides a biological function. The functionalization may also be embodied in the form of a mechanical function, such as a sharp tip enabling localized mechanical manipulation of an associated object. In general, it is encompassed by the invention that the microdevice may also act to deliver space-targeted and time-programmed stimuli to an associated object which may be, for example, a human cell. A possible target would be optical excitation of receptors on the cell membrane, which is known to link with the cell's signalling network to initiate biochemical processes within the cell. Another prospect would be purely mechanical stimulation for probing mechanotransduction—a cellular mechanism that converts mechanical signals on the membrane into biochemical response within the cell, which can figure in embryogenesis and cancer metastasis. A micro-to-nano coupling approach is relevant for biology given that nanoscale biological processes must be understood in the context of their host living cells, which are orders of magnitude larger (e.g., mammalian cells can be tens of microns in diameter).

In another particular embodiment, the microdevice comprises an optically conductive portion where through light is transmitted, and the optically conductive portion comprising optically active an optically active substance, such as dopants, such as dyes, such as rare earth elements. The optically conductive portion may in a particular embodiment be a light guiding element. Possible advantages of having an optically conductive portion where through light is transmitted, which portion comprises an optically active substance, may include the possibility of exploiting non-linear effects or amplification.

In one particular embodiment, the microdevice is arranged so that the direction of the emitted EMR is dependent, such as directly dependent, on the orientation of the microdevice. This may, for example, be realized by guiding the EMR to be emitted in an EMR guiding element. An advantage of linking the direction of emitted light with the orientation of the microdevice may be that the direction of emitted light is controlled once the orientation of the microdevice is controlled. Another advantage may be, that in an embodiment where the microdevice receives EMR and guides and/or reflects the received EMR so as to be emitted, the direction of the emitted EMR may be controlled, such as changed, without changing the direction of the received EMR. For example, in a laboratory setup with a source of EMR for supplying the EMR (which EMR is received by the microdevice), the source of EMR could be kept substantially stationary.

In an embodiment, there is provided a microdevice for emitting electromagnetic radiation, the microdevice comprising
a first electromagnetic radiation emitting unit arranged to emit electromagnetic radiation,
means for enabling simultaneous non-contact spatial control over the microdevice in terms of:
   translational movement in three dimensions, and
   rotational movement around at least two axes,
      wherein the means for enabling non-contact spatial control over the microdevice are arranged for being spatially controlled by forces applied by electromagnetic radiation, and wherein the first electromagnetic radiation emitting unit and the means for enabling spatial control over the microdevice are structurally linked, wherein the first electromagnetic radiation emitting unit comprising:
an electromagnetic radiation in-coupling element arranged to receive incoming electromagnetic radiation,
an electromagnetic radiation out-coupling element being structurally linked to the electromagnetic radiation in-coupling element and the electromagnetic radiation out-coupling element being arranged to emit electromagnetic radiation in response to said incoming electromagnetic radiation, and
   wherein the electromagnetic radiation in-coupling element is arranged to receive incoming electromagnetic radiation having a first direction and the electromagnetic radiation out-coupling element is arranged to emit electromagnetic radiation having a second direction where the first direction and the second direction are non-parallel, such as an angle between the first and second direction is at least 10 degrees, such as at least 20 degrees, such as at least 30 degrees, such as at least 45 degrees, such as at least 60 degrees, such as at least 80 degrees, such as substantially 90 degrees, such as substantially right-angled, such as right-angled,
   or
   wherein the electromagnetic radiation in-coupling element is arranged to receive incoming electromagnetic radiation having a first direction and the electromagnetic radiation out-coupling element is arranged to emit electromagnetic radiation having a second direction where the electromagnetic radiation out-coupling element is spatially displaced with respect to the electromagnetic radiation in-coupling element along a direction being orthogonal to the first direction, and where the first direction and the second direction are substantially parallel, such as angle between the first direction and the second direction being within 10 degrees, such as within 5 degrees, such as within 2 degrees, such as within 1 degree, such as parallel.

By having the first and the second directions being non-parallel, where the in-coupling element and the out-coupling element are spatially displaced with each other or not being displaced with respect to each other along a direction being orthogonal to the first direction, or by having the first and second direction being parallel where the in-coupling element and the out-coupling element are spatially displaced with respect to each other along a direction being orthogonal to the first direction, it is understood that the EMR may be redirected such as to bend it around corners or to have it being incident at a position it would not otherwise have been incident upon, and this spatial control of the EMR may take place in a controlled manner since it may depend on the controllable position and orientation of the microdevice. A possible advantage of this may be, that an object under examination which receives the emitted EMR, need not be placed on the axis of the incoming EMR, where it may be subjected to EMR which for some reason is not received by the radiation in-coupling element and may thus be described as background EMR. This in turn means that the object under examination may be examined with improved signal to noise ratio, because of the reduction in background EMR. Another possible advantage may be, that the in-coming EMR may be stationary, whereas the emitted EMR (from the out-coupling element) may be moved around spatially by controlling the position and orientation of the microdevice.

By ‘spatially displaced’ may in particular embodiments be understood at least a distance corresponding to the width of the incoming EMR, such as the width of the incoming EMR which is coupled into the in-coupling element, such as at least the width multiplied by a factor of 2, 3, 4, 5, 6, 7, 8, 9, 10, 20, 50, 100, 250, 500 or 1000. It is further understood that in the present context, such as in the context of this particular embodiment, such as in the context of defining ‘spatially displaced’, the ‘incoming EMR’ may be defined with respect to the in-coupling element, so that the width of the incoming EMR may be understood as the width of a beam of EMR which may be coupled into the microdevice via the in-coupling element, such as the width of the area (in a direction orthogonal to the first direction) of the in-coupling element which may collect photons. For non circular cross-sections of this area, the width is to be calculated as squareroot(4*Area/pi), i.e., the diameter of the area if the cross-section had been circular. In particular embodiments the electromagnetic radiation out-coupling element is spatially displaced with respect to the electromagnetic radiation in-coupling element by at least a distance of 1, 2, 3, 4, 5, 6, 7, 8, 9, 10, 20, 50, 100, 250, 500 or 1000 micrometer.

In a particular embodiment, the electromagnetic radiation in-coupling element is arranged to receive incoming electromagnetic radiation having a first direction and the electromagnetic radiation out-coupling element is arranged to emit electromagnetic radiation having a second direction where the first direction and the second direction are non-parallel, such as an angle between the first and second direction is at least 10 degrees, such as at least 20 degrees, such as at least 30 degrees, such as at least 45 degrees, such as at least 60 degrees, such as at least 80 degrees, such as substantially 90 degrees, such as substantially right-angled, such as right-angled, where the electromagnetic radiation out-coupling element is spatially displaced with respect to the electromagnetic radiation in-coupling element along a direction being orthogonal to the first direction.

In another embodiment, there is provided a microdevice for emitting electromagnetic radiation, the microdevice comprising
a first electromagnetic radiation emitting unit arranged to emit electromagnetic radiation,
means for enabling simultaneous non-contact spatial control over the microdevice in terms of:
   translational movement in three dimensions, and
   rotational movement around at least two axes,
      wherein the means for enabling non-contact spatial control over the microdevice are arranged for being spatially controlled by forces applied by electromagnetic radiation, and wherein the first electromagnetic radiation emitting unit and the means for enabling spatial control over the microdevice are structurally linked, wherein the first electromagnetic radiation emitting unit comprising:
an electromagnetic radiation in-coupling element arranged to receive incoming electromagnetic radiation,
an electromagnetic radiation out-coupling element being structurally linked to the electromagnetic radiation in-coupling element and the electromagnetic radiation out-coupling element being arranged to emit electromagnetic radiation in response to said incoming electromagnetic radiation, and
   wherein the electromagnetic radiation in-coupling element and the electromagnetic radiation out-coupling element are arranged so that the electromagnetic radiation out-coupling element may emit electromagnetic radiation being non-coaxial with the incoming electromagnetic radiation, such as the electromagnetic radiation in-coupling element and the electromagnetic radiation out-coupling element being arranged so that the electromagnetic radiation out-coupling element is arranged for emitting electromagnetic radiation being non-coaxial with the incoming electromagnetic radiation, such as the electromagnetic radiation out-coupling element being spatially displaced with respect to the electromagnetic radiation in-coupling element along a direction being orthogonal to the first direction and/or the EMR in-coupling element being arranged to receive incoming EMR having a first direction and the EMR out-coupling element being arranged to emit EMR having a second direction where the first direction and the second direction are non-parallel.

By ‘non-coaxial’ is understood that the EMR emitted from the radiation out-coupling element (which hereafter may be referred to as emitted EMR) is not coaxial with the incoming EMR, such as the incoming EMR and the emitted EMR being substantially described by rays of EMR which are non-parallel (such as an angle between the first and second direction is at least 10 degrees, such as at least 20 degrees, such as at least 30 degrees, such as at least 45 degrees, such as at least 60 degrees, such as at least 80 degrees, such as substantially 90 degrees, such as substantially right-angled, such as right-angled), and/or spatially displaced so as not to be on the same axis, even if the incoming EMR and the emitted EMR may be parallel. A possible advantage of this may be, that an object under examination which receives the emitted EMR, need not be placed on the axis of the incoming EMR, where it may be subjected to EMR which for some reason is not received by the radiation in-coupling element and may thus be described as background EMR. This in turn means that the object under examination may be examined with improved signal to noise ratio, because of the reduction in background EMR. In a particular embodiment, ‘non-coaxial’ may be understood as the electromagnetic radiation out-coupling element being spatially displaced with respect to the electromagnetic radiation in-coupling element along a direction being orthogonal to the first direction and/or the EMR in-coupling element being arranged to receive incoming EMR having a first direction and the EMR out-coupling element being arranged to emit EMR having a second direction where the first direction and the second direction are non-parallel.

In another embodiment there is provided a microdevice for emitting EMR, comprising
means for enabling simultaneous non-contact spatial control over the microdevice in terms of:
   translational movement in three dimensions, and
   rotational movement around at least three axes.

According to this embodiment, the microdevice enables control over all six degrees of freedom, i.e., the microdevice may be moved in any direction and may be rotated around any axis. Since the position and angular displacement of the microdevice in all three spatial dimensions and around all three spatial axes is controlled, the position and orientation of the microdevice can be completely controlled. An advantage of being able to control the rotation around all axes, i.e., including the axis along which the EMR is emitted may be that if the EMR is polarized, then the direction of polarization of the emitted EMR may be held fixed or alternatively changed in a controlled manner.

In yet another embodiment there is provided a microdevice for emitting EMR, wherein the means for enabling spatial control over the microdevice comprise at least one EMR controllable handle, such as a plurality of EMR controllable handles, such as at least 3 EMR controllable handles.

By ‘EMR controllable handle’ is understood an element which may itself be spatially manipulated, i.e., be positioned or moved in space, by applying EMR. In one exemplary embodiment, an EMR controllable handle may be embodied in the form of an EMR controllable handle, such as a micrometer-sized, spherical dielectric particle which may be moved or held at a fixed position in an optical trap or optical tweezer. An advantage of having a microdevice which comprises one or more EMR controllable handles may be that the EMR controllable handles may enable the spatial control over the microdevice by applying EMR to the EMR controllable handles which are rigidly, structurally linked to other elements, such as the EMR emitting unit, within the microdevice. An advantage of having rigid structural linkages within the microdevice may be, that this ensures that the relative positions of the individual elements of the microdevice are fixed, and hence that knowing the position of some of the elements, e.g., the optical handles, enables deriving the position of other elements, e.g., a functionalized tip or a light out-coupling element. In other words, even with using only far-field optics, the microdevice can couple optical forces to the nanotip, such as a light out-coupling element, to achieve nanoscale manoeuvrability. Having specified the geometry of the light-driven microdevice, one can conveniently pinpoint the nanotip location, without superresolution, by inferring its position from the easily tracked micron-sized microdevice.

In yet another embodiment there is provided a microdevice for emitting EMR, wherein the microdevice further comprises an emitter, the emitter being arranged for emitting EMR.

By ‘emitter’ is understood a unit which is capable of generating EMR, i.e., to convert an amount of energy into one or more photons. In a further embodiment there is provided a microdevice for emitting EMR, wherein the emitter is arranged to receive incoming EMR and in response emit EMR. In another further embodiment microdevice for emitting EMR, wherein the emitter may be chosen from the group comprising: a fluorophore, a quantum dot, an EMR emitting diode, a LASER. It is understood that a fluorophore may absorb energy in the form of one or more photons and in response emit one or more photons. Quantum dots are known in the art and may be described as fluorescent semiconductor nanoparticles. It is understood that emitters exist which may receive electrical energy which is converted into emitted photons, examples include electrically pumped quantum dots and EMR emitting diodes, such as light emitting diodes (LEDs). An advantage of having a microdevice which comprises an emitter may be that the microdevice may emit photons without having to receive and re-emit photons. The microdevice may in other words carry its own source of EMR.

In particular embodiments, the emitter is understood to emit EMR within the visible range of the electromagnetic spectrum, such as within 380-750 nm.

In yet another embodiment there is provided a microdevice for emitting electromagnetic radiation, wherein the emitter being arranged for emitting electromagnetic radiation within the visible range of the electromagnetic spectrum, such as within 380-750 nm.

In yet another embodiment there is provided a microdevice for emitting EMR, the microdevice further comprising:
an output element for shaping the EMR emitted from the first EMR emitting unit.

By ‘output element for shaping the EMR’ is understood an element which receives EMR at a first point and which re-emits the EMR at a second point and where the EMR is shaped, such as being focused, being changed from paraxial EMR to divergent EMR. Specific examples of output elements for shaping the EMR may include mirrors and lenses, where a lens is understood to be a refracting device (i.e., a discontinuity in the prevailing medium) that reconfigures a transmitted energy distribution. An advantage of having an output element for shaping the EMR may be, that the emitted EMR may thus be designed according to specific needs. For example, the EMR may be focused on a point a given distance away, or the EMR may be shaped into being less divergent so as not to spread too much when propagating across a distance. Another advantage may be that light emitted from a point source, such as a quantum dot, may be collected over a relatively large solid angle and redirected in a certain direction, e.g., by means of a Fresnel lens. This may be advantageous for having the EMR being primarily emitted in a certain direction.

In yet another embodiment there is provided a microdevice for emitting EMR, wherein the largest dimension of the microdevice is less than 1 millimetre, such as less than 750 micrometres, such as less than 500 micrometres, such as less than 250 micrometres, such as less than 100 micrometres, such as less than 50 micrometres, such as less than 10 micrometres. One advantage of having a relatively small microdevice may be that the microdevice is lighter, i.e., of lower mass, with respect to larger devices. This in turn means that less force is required to accelerate and decelerate the device during translational and rotational movements.

In yet another embodiment there is provided a microdevice for emitting EMR, wherein the first EMR emitting unit and the means for enabling spatial control over the microdevice are spatially separated from each other.

By ‘spatially separated from each other” is understood that the respective elements are separated from each by a finite spatial distance. The finite spatial distance may in particular embodiments be fixed, such as fixed by attaching each element in a certain position on the rigid element. An advantage of having the first EMR emitting unit and the means for enabling spatial control over the microdevice being spatially separated from each other may be that such separation facilitates that the EMR for spatially controlling the microdevice is not mixed with the EMR emitted from the radiation emitting unit. This may for example enable the wavelength which is being emitted from the first EMR emitting unit to be chosen independently of the wavelength for spatially controlling the microdevice, and may furthermore serve to ensure that the EMR emitted from the first EMR emitting unit is contaminated with EMR used to spatially control the microdevice.

In yet another embodiment there is provided a microdevice for emitting EMR, the first EMR emitting unit comprising:
an EMR in-coupling element arranged to receive incoming EMR,
an EMR out-coupling element being structurally linked to the EMR in-coupling element and the EMR out-coupling element being arranged to emit EMR in response to said incoming EMR.

The EMR in-coupling element may be, for example, a lens element or another element which serves to collect EMR and aids in guiding the EMR from the EMR in-coupling element to the EMR out-coupling element. An advantage of this may be, that the microdevice need not carry its own source of EMR in order to be able to emit EMR, since the EMR may be received from the microdevice by the EMR in-coupling element, then propagates to the EMR out-coupling element and subsequently emitted from microdevice via the EMR out-coupling element. It is understood that the microdevice may comprise a plurality of EMR in-coupling elements and/or a plurality or EMR out-coupling elements. The plurality of EMR in-coupling elements may be arranged so that EMR propagates to a single EMR out-coupling element or to a plurality of EMR out-coupling elements. Similarly, the plurality of EMR out-coupling elements may be arranged so that EMR propagates from a single EMR in-coupling element or from a plurality of EMR in-coupling elements. A possible advantage of having, e.g., a plurality of EMR in-coupling elements may be that each of the EMR in-coupling elements may enable receipt of EMR from a certain direction so that the microdevice may be oriented in different orientations while still being able to receive EMR via one of the EMR in-coupling elements even if the source of EMR in the particular setup is not suited to allow the microdevice to receive EMR via another EMR in-coupling element.

In yet another embodiment there is provided a microdevice for emitting EMR, wherein the microdevice comprises an EMR guiding element. In a particular embodiment the EMR guiding element is arranged from a source of EMR to an EMR out-coupling element. In another particular embodiment the EMR guiding element is arranged from an EMR in-coupling element to an EMR out-coupling element. An advantage of having an EMR guiding element may be that the EMR may then be guiding in a controlled manner. Another advantage may be that the EMR may be guided independent of the surrounding medium. Another advantage may be that an EMR guiding element may enable that the EMR is guided along a route of propagation which need not be straight.

In yet another embodiment there is provided a microdevice for emitting EMR, wherein EMR in-coupling element is arranged to receive incoming EMR having a first direction and the EMR out-coupling element is arranged to emit EMR having a second direction where the first direction and the second direction are non-parallel, such as an angle between the first and second direction is at least 10 degrees, such as at least 20 degrees, such as at least 30 degrees, such as at least 45 degrees, such as at least 60 degrees, such as at least 80 degrees, such as substantially 90 degrees, such as substantially right-angled, such as right-angled. The means for changing the direction of the EMR between the EMR in-coupling element and the EMR out-coupling element may include any one or more or a combination of a mirrors, EMR guiding elements, prisms or lenses. A possible advantages of having the received EMR being non-parallel with the emitted EMR is that the source emitting EMR to the microdevice need not be aligned with a direction of emission of EMR from the microdevice. In one particular example, the incoming EMR propagates along a vertical axis and the EMR out-coupling element is arranged to emit in a horizontal direction. The EMR is in this exemplary embodiment re-directed 90 degrees, which enables the microdevice to emit EMR in any one direction in the horizontal plane while the direction of the incoming EMR is kept fixed along a vertical direction.

In yet another embodiment there is provided a microdevice for emitting EMR, wherein the EMR out-coupling element is arranged to confine the propagating mode spatially below the diffraction limit. The diffraction limit is well-known in the art (where it also known as the Abbe diffraction limit) and fundamentally delimits conventional microscopy from resolving areas smaller than approximately half the wavelength of the electromagnetic light used for imaging. In particular embodiments, this confiment is realized using a small aperture. In other particular embodiments, this is realized using plasmonic structures (see also FIGS. 15-16 and corresponding text). Possible advantages are well known, and may in particular include the improvement in resolution, since smaller areas are resolved.

According to a second aspect of the invention, there is provided a system for emitting EMR onto an associated object, the system comprising:
a microdevice for emitting EMR according to the first aspect,
a second EMR emitting unit being adapted to generate the EMR for spatially controlling the microdevice according to the first aspect.

According to a third aspect of the invention, the invention further relates to a method for emitting EMR, the method including:
spatially controlling the microdevice according to the first aspect by applying EMR within a volume comprising the microdevice according to the first aspect,
emitting EMR from the microdevice according to the first aspect.

According to a further embodiment, there is provided a method for emitting EMR, the method including:
spatially controlling a plurality of microdevices according to the first aspect by applying EMR within a volume comprising the plurality of microdevices according to the first aspect,
emitting EMR from the plurality of microdevices according to the first aspect.

In another embodiment, there is provided a method, wherein the spatial controlling of the microdevice according to the first aspect by applying EMR, and the emitting of EMR from the microdevice of claim 1 is taking place simultaneously. By having the spatial controlling and the emitting of EMR from the microdevice taking place simultaneously, it is enabled to control, such as fix, move or orient, the microdevice during emission of EMR. This in turn facilitates that associated objects whereupon EMR is emitted may be scanned or tracked. Another advantage is that supporting structures, such as a substrate whereupon the microdevice would have to be placed during emission of EMR, are not needed.

In another embodiment, there is provided a method further comprising
the microdevice according to the first aspect receiving EMR, and
the microdevice according to the first aspect emitting EMR in response to said receiving EMR.

It is understood that the microdevice may emit EMR directly, such as simply reflecting or re-directing the received EMR, or indirectly, such as by first exciting, e.g., a fluorophore or a quantum dot with the received EMR and subsequently emitting EMR from the fluorophore or quantum dot following decay of the excited state.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

The microdevice for emitting EMR according to the invention will now be described in more detail with regard to the accompanying figures. The figures show one way of implementing the present invention and is not to be construed as being limiting to other possible embodiments falling within the scope of the attached claim set.

FIG. 1 shows a perspective view of a microdevice,

FIG. 2 shows a sideview of the microdevice,

FIG. 3 shows a microscope image of a microdevice,

FIG. 4 shows a microscope image of the same microdevice as in FIG. 3,

FIG. 5 shows a top view of the microdevice,

FIG. 6 shows a top view of an alternative embodiment of a microdevice,

FIG. 7 shows a top view of an alternative embodiment of a microdevice,

FIG. 8 shows a side view of an embodiment according to the invention,

FIGS. 9-11 show a perspective view, a top view and a front view of a particular embodiment,

FIG. 12 is similar to FIG. 1 except that the EMR out-coupling element in the embodiment of the present figure has a round shape,

FIG. 13 is similar to FIG. 1 except that the linking structures are functioning as optical handles,

FIG. 14 is similar to FIG. 1 except that the EMR out-coupling element in the embodiment of the present figure has a round shape and that the linking structures with their optical handles have been removed,

FIGS. 15-16 show respectively a perspective view and a side view similar to FIGS. 1-2,

FIG. 17 shows an application of an embodiment of the microdevice,

FIG. 18 shows an application of an embodiment of the microdevice,

FIG. 19 shows an embodiment which features an emitter,

FIG. 20 shows a simulation of the light intensity during light guiding through a microdevice similar to the microdevice shown in FIGS. 1-5.

FIGS. 21-22 show experimental data in the form of images of an embodiment of the microdevice,

FIGS. 23-25 show light coupling and optical manipulation experiments,

FIG. 26 shows a SEM image of a representative two-photon polymerized structure being a bent waveguide (bending radius R being approximately 8

FIG. 27 shows another type of micro device similar to the micro devices depicted in FIGS. 1-2,

FIG. 28 is an illustration of the micro device of FIG. 27,

FIG. 29 is a side view of a micro device,

FIG. 30 is a top view of a micro device,

FIG. 31 is a top view of an alternative embodiment of a micro device,

FIG. 32 shows a side view of another type of a micro device,

FIG. 33 is a perspective view similar to FIG. 1,

FIG. 34 shows a side view of the embodiment depicted in FIG. 33.

### DETAILED DESCRIPTION OF AN EMBODIMENT

In the following section, light is used interchangeably with EMR. It is understood that light may be used in particular embodiments, but that the exemplary use of light in those embodiments do not constrain the invention to use of light only.

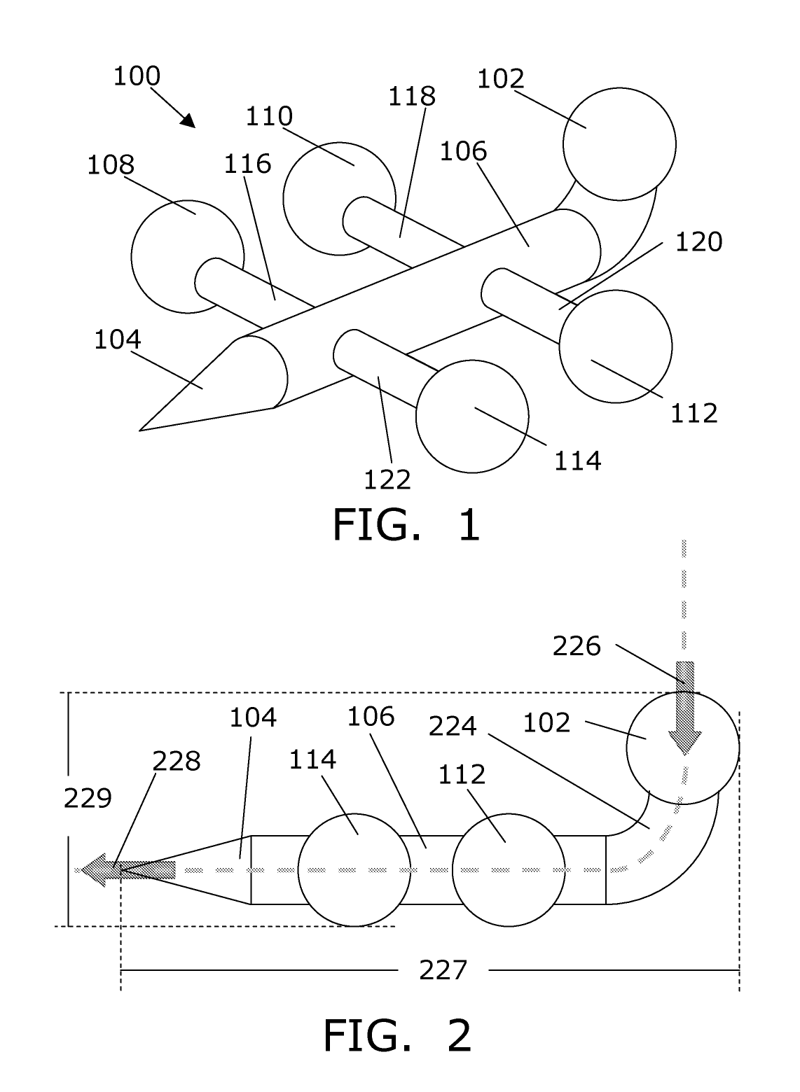

FIG. 1 shows a perspective view of a microdevice 100 according to an embodiment of the invention, the microdevice 100 features a light in-coupling element 102, a light out-coupling element 104. The light in-coupling element 102 is arranged to receive light and guide the received light into a light guiding element 106 which optically connects the light in-coupling element with the light out-coupling element. Thus, light may be received at light guiding element 102 and guided by light guiding element 106 to the light out-coupling element 104 where it is emitted. The optical elements 102, 104, 106 thus form an EMR emitting unit which enables emission of EMR, such as light. The microdevice further comprises means for enabling non-contact spatial control over the microdevice, the means being embodied by optical handles 108, 110, 112, 114. Each of the optical handles is structurally linked to the light guiding element 106 via linking structures 116, 118, 120, 122. In the present embodiment, the light out-coupling element 104 is shaped conically, an advantage of such shape may be that the microdevice thus has a sharp tip which may be used to physically contact and manipulate other objects, such as a biological cell. Another advantage may be that the light out-coupling element may serve as an output element for shaping the EMR emitted from the first EMR emitting unit.

FIG. 2 shows a sideview of the microdevice 100 depicted in FIG. 1. In FIG. 2 a bend part 224 of the light guiding element 106 is more clearly seen. The bend part 224 of the light guiding element enables incoming light 226 to be received by the light in-coupling element 102 and to be guided through the light guiding lement 106 and through the light out-coupling part 104 as emitted light 228. The skilled person will readily realize that the optical path is bi-directional, and light may consequently also be collected at the light out-coupling element 104, be guided through the light guiding element 106 and emitted from the light in-coupling element 102. FIG. 2 also indicates a length 227 and a height 229 of the microdevice. In an exemplary embodiment the length 227 is 35 micrometer and the height 229 is 20 micrometer, but other dimensions in the micrometer region, such as within 1 micrometer to 1 millimeter are conceivable.

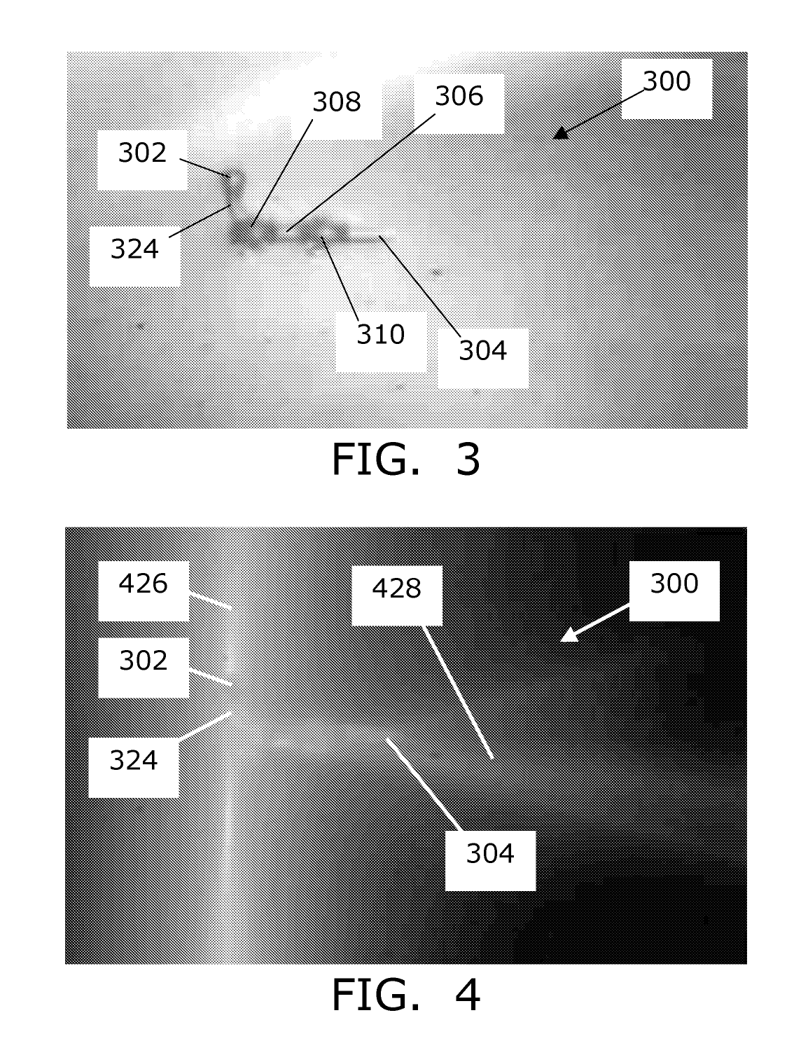

FIG. 3 shows a microscope image of a microdevice 300 for emitting EMR. The microdevice is illuminated with white light. The microdevice is structurally similar to the microdevice schematically depicted in FIGS. 1-2. FIG. 3 is similar to FIG. 2 except that the microdevice in FIG. 2 is pointing to the left where the microdevice in FIG. 3 is pointing to the right. In FIG. 3 the microdevice is shown from the side and it is possible to see the light in-coupling element 302 with bend part 324, the light out-coupling element 304, the light guiding element 306 and optical handles 308, 310.

FIG. 4 shows the same microdevice 300 as in FIG. 3. The microdevice is immersed in an fluid comprising a fluorescent dye. As opposed to FIG. 3, in FIG. 4 the white light illumination has been turned off so that incoming light 426 can clearly be seen since it excites fluorophores in the fluorescent dye. The incoming light 426 coming from the top is incident on the light in-coupling element 302. Furthermore the in-coupling element couples the incoming light into the microdevice 300 and the in-coupled light is guided through the light guiding element so as to be emitted through the light out-coupling element 304. The emitted light 428 is also clearly visible in FIG. 4.

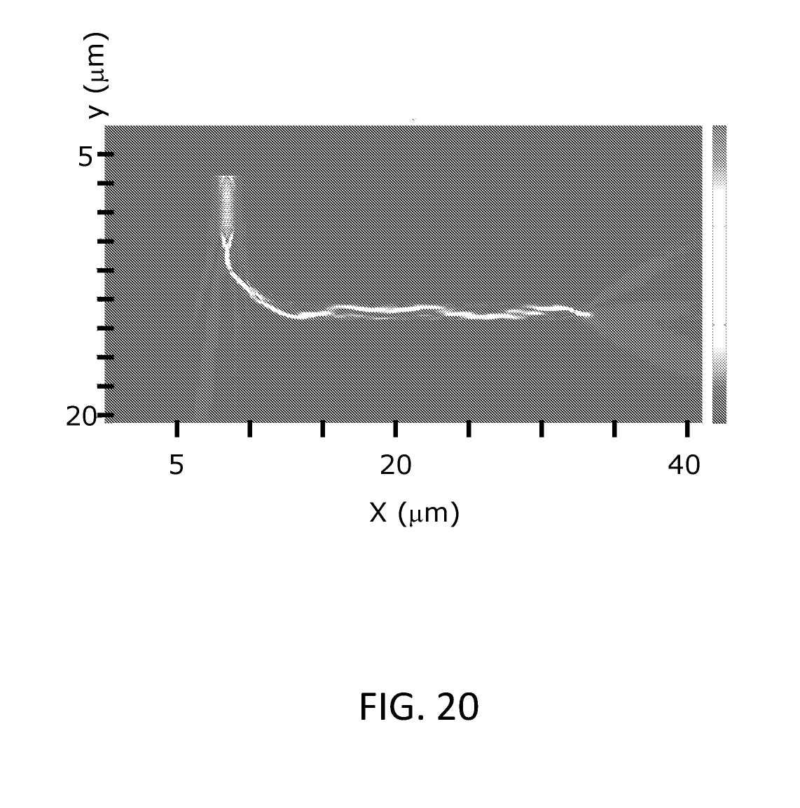

In other words, the snapshots in FIGS. 3-4 show images from side-view video microscopy taken during experiments simulating targeted light delivery by coupling light from an external source to a steered subwavelength tip through an optically trapped and manipulated structure. The structure was trapped in fluorescent media (calcium orange) to image and track the external light source using filtered fluorescence to minimize noise from scattered trapping beams. The results illustrate that the structure can guide light and, hence, direct energy from an external source towards a user-defined target location using concurrent optical control of the structure's three-dimensional position and angular orientation. The observed light from the tip replicates the characteristic two-pronged output seen in the accompanying simulation (FIG. 20) of light guiding through a microdevice, modelled using the finite difference time domain method. The relatively intense light regions seen near the tip indicates that the microtools can be used for highly localized illumination, as opposed to customary direct illumination from the top (compare with the beam profile near the in-coupling end of the structure). The structural features can be designed to regulate and optimize the light-guiding process. For example, the output can be controlled by varying the taper profile. Moreover, there is much flexibility in the choice of light source, as opposed to using nonlinear effects for in situ light source creation, whose wavelengths would be restricted by the nonlinear material.

These results demonstrate the paradigm of structure-mediated micro-to-nano coupling for delivering targeted mechanical and optical stimulation. This can set the stage for developing more advanced coupling structures that incorporate diverse functionalities. Potential applications include guiding and manipulation of nanophotonic devices and components including, among others, chemically functionalized tips, 3D-maneouvrable Tip-Enhanced Raman Spectroscopy (described in the reference “Nano-imaging through tip-enhanced Raman spectroscopy: Stepping beyond the classical limits”, Verma, P. et al., Laser and Photonics Reviews 4, 548-561 (2010), which is hereby incorporated by reference in its entirety), metallic nanostructures and metamaterials for applications based on nanoscale light control and manipulation with plasmonics (described in the referende “Plasmonics beyond the diffraction limit”, Gramotnev, D. K. et al., Nature Photonics 4, 83-91 (2010), which is hereby incorporated by reference in its entirety) crystalline and semiconductor nanowires for generating coherent light, waveguiding, optical probing and other light management functions. Furthermore, the structure may be optimized for bidirectional light transport to also couple light from the tip back to the far-field optics for nano-endoscopy or micro-endoscopy. Extending the micro-to-nano coupling, the structure may serve to not only couple mechanical forces and optical excitation, but may furthermore comprise means for enabling transport of matter as well using nanofluidics through nanotubes. The biological possibilities for optically steered nanotools abound, from monitoring processes in vivo to delivering spatially targeted mechano-chemical stimuli for developing and testing biological models of cellular behaviour. These nanotools can provide dynamic experimental stimuli when used together with static technologies for regulating cell function.

The microdevice of FIGS. 3-4 is fabricated by using the two-photon microfabrication system described in “Integrated optical motor”, Kelemen, L. et al., Appl. Opt. 45, 2777-2780 (2006) which is hereby incorporated by reference in its entirety. The procedure includes a two-minute soft bake of spin-coated photoresist layer (SU8 2007, Microchem) before laser illumination and a 10 minutes post bake after the illumination, both at 95° C. on a hot plate. Microstructures were formed by scanning tightly focused ultrashort pulses from a Ti:sapphire laser (λ=796 nm, 100 fs pulses, 80 MHz repetition rate, 3 mW average power) in the photoresist. The laser pulses were focused by an oil-immersion microscope objective (100× Zeiss Achroplan, 1.25 NA objective; DF-type immersion oil Cargille Laboratories, formula code 1261, n=1.515). The focal spot was scanned relative to the resin at speeds of 10 μm/s for the spheres and 5 μm/s for the connecting rods and tip to solidify voxels with minimum transverse and axial feature sizes of 0.4±0.1 μm in transverse and 1±0.1 μm in longitudinal directions, respectively. A sample design file may be used for specifying the laser path and dimensions for a given microdevice. An exemplary microdevice may have dimensions of 35 μm×20 μm×6 μm (corresponding to length×width×height) and having spherical handles 6 μm in diameter.

### Sample Preparation

After developing and harvesting the microdevices, they may be stored in a solvent containing a mixture of 0.5% surfactant (Tween 20) and 0.05% azide in water. The surfactant prevents the microdevices from sticking to each other and to the sample chamber; the azide prevents microbial growth during storage. To use the microdevices, the sample is centrifuged to let the microdevices settle to the bottom for easier collection. For the light coupling experiments, the microdevices are first mixed with a fluorescent solvent (calcium orange diluted with ethanol) before loading into the cytometry cell)

### Optical Micromanipulation

The so-called BioPhotonics Workstation was used. The BioPhotonics workstation is described in the reference “Independent trapping, manipulation and characterization by an all-optical biophotonics workstation”, by H. U. Ulriksen et al., J. Europ. Opt. Soc. Rap. Public. 3, 08034 (2008) which is hereby incorporated in entirety by reference. The BioPhotonics Workstation uses near-infrared light (λ=1064 nm) from a fibre laser (IPG). Real-time spatial addressing of the expanded laser source in the beam modulation module produces reconfigurable intensity patterns. Optical mapping two independently addressable regions in a computer-controlled spatial light modulator as counterpropagating beams in the sample volume enables trapping a plurality of micro-objects (currently generates up to 100 optical traps). The beams are relayed through opposite microscope objectives (Olympus LMPLN 50×IR, WD=6.0 mm, NA=0.55) into a 4.2 mm thick HelIma cell (250 μm×250 μm inner cross section). A user traps and steers the desired object(s) in three dimensions through a computer interface where the operator can select, trap, move and reorient cells and fabricated microdevices with a mouse or joystick in real-time. Videos of the experiments are grabbed simultaneously from the top-view and side-view microscopes. It is also contemplated that other means that the BioPhotonics Workstation may be used together with the present invention in order to spatially control the microdevice, such as optical tweezers, such as scanning optical tweezers, such as holographic optical tweezers (see the reference “Holographic optical tweezers and their relevance to lab on chip devices”, M. Padgett and R. Leonardo, Lab Chip, 2011, 11, 1196, which is hereby incorporated by reference), such as dielectrophoresis.

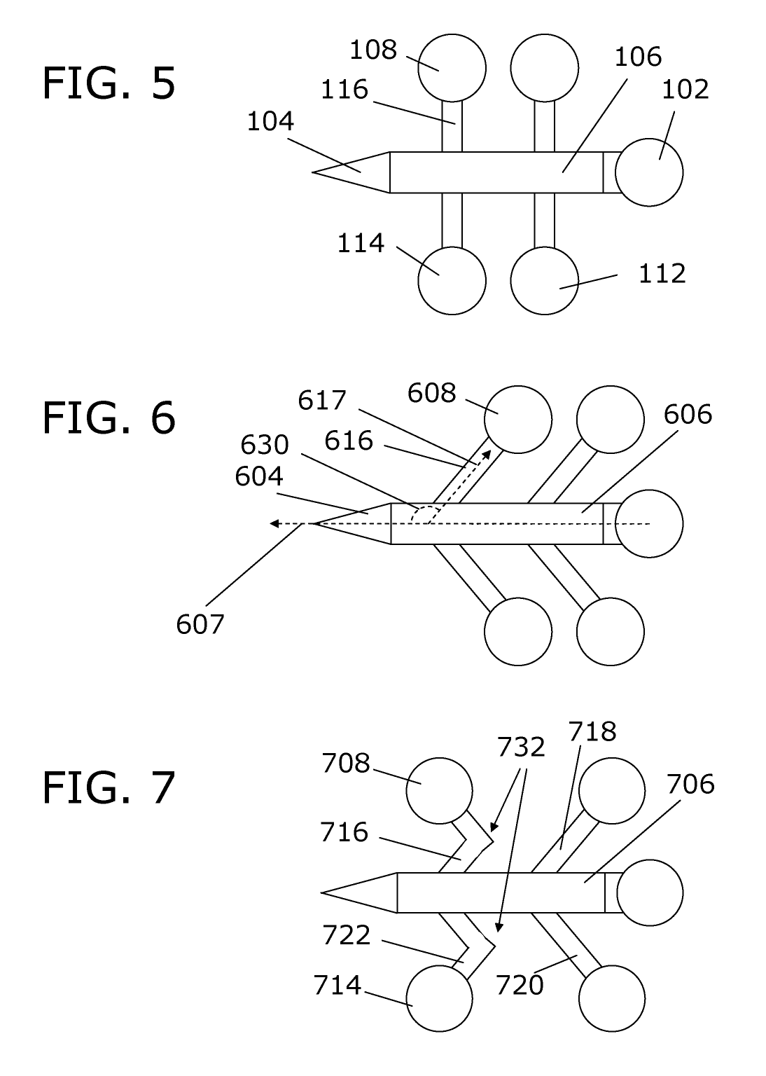

FIG. 5 shows a top view of the microdevice which is also schematically depicted in FIGS. 1-2.

FIG. 6 shows a top view of an alternative embodiment of a microdevice where the linking structures are bent so as to present an obtuse angle with respect to the optical path of the light guiding element 606. For example, the linking structure 616 is bent so that there will be an obtuse angle 630 between a vector 607 pointing in the direction of the optical path in the light guiding element and a vector 617 being parallel with the axis of the linking structure 616 and pointing in a direction from the light guiding element 606 to the optical handle 608. A consequence of the obtuse angle 630 may be that a smaller amount of light travelling in the light guiding element 606 in a direction towards the light out-coupling element 604 may “leak” out of the light guiding element 606 through the linking structure 616.

FIG. 7 shows a top view of an alternative embodiment of a microdevice where the linking structures 716, 718, 720, 722 are bent so as to present an obtuse angle with respect to the optical path of the light guiding element 706, as in FIG. 6. Furthermore, two of the linking structures 716, 722 are non-straight so that the obtuse angle with respect to the light guiding element is maintained in a region near the light guiding element while in a region near the respective optical handles 708, 714 are non-parallel with each other and non-parallel with the linking structures 718, 720 placed in the right side of the present figure. This may be advantageous since there is a risk that the EMR applying a force to a particular optical handle may be less efficient in applying a force in the direction of the linking structure if the linking structure matches the refractive index of the optical handle. By having the linking structures placed in different directions for different handles, this problem may be reduced since the reduced efficiency of applying a force in a given direction is not in the same direction for all handles.

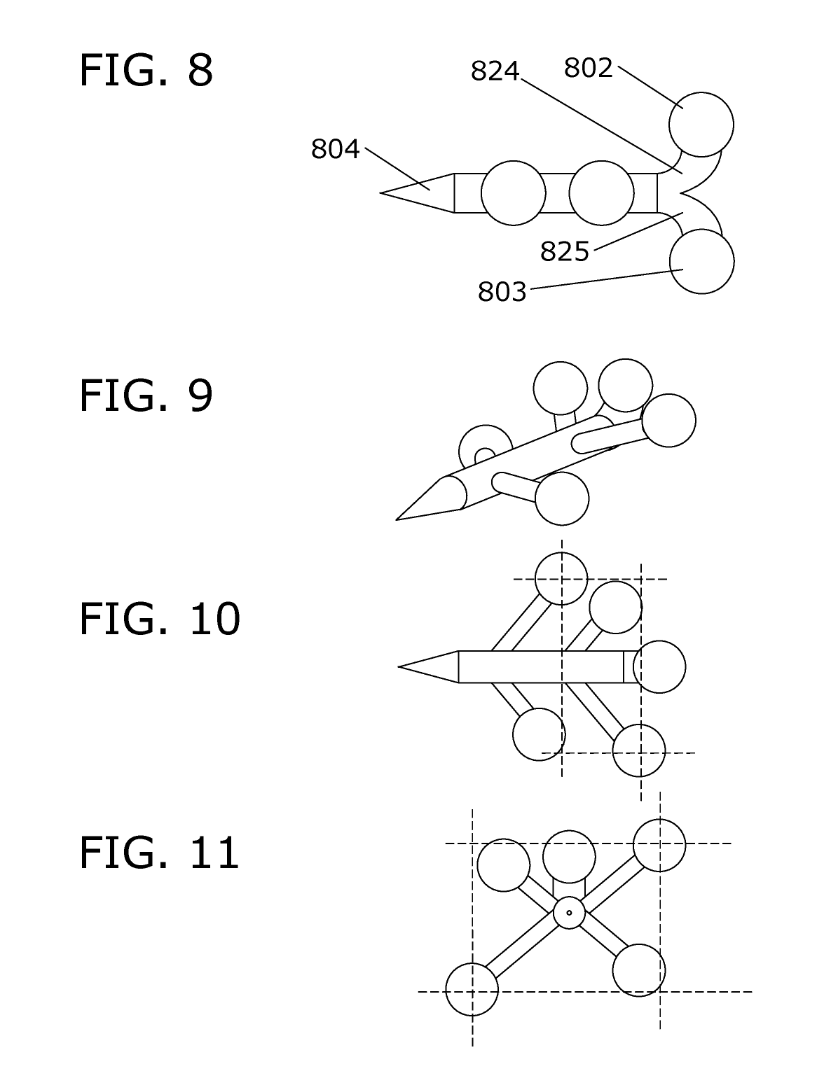

FIG. 8 shows a side view of an embodiment according to the invention, which is similar to the embodiment shown in FIG. 2 except that the particular embodiment of FIG. 8 has two in-coupling elements 802, 803 and correspondingly two bend parts 824, 825 of the light guiding elements. In this particular embodiment, both in-coupling elements 802, 803 are coupled to the same EMR out-coupling element 804. With this particular configuration, it may be possible to have EMR propagating from either the top or the bottom and still having the microdevice receiving the EMR through one in-coupling element 802 or the other in-coupling element 803. Furthermore, the microdevice may be turned 180 degrees around and axis from left-to-right in the figure, and still being able to receive light propagating in a vertical direction, i.e., the microdevice may still be able to receive vertically propagating EMR even if it is turned upside down. Other configurations, e.g., with more than two in-coupling elements are also envisioned to be advantageous.

FIGS. 9-11 show respectively a perspective view, a top view and a front view of a particular embodiment, where the linking structures have different angles with respect to a horizontal plane (corresponding to the plane of the paper in the top view of FIG. 10). Furthermore, the linking structures have different lengths as is indicated by the dotted lines in FIGS. 10-11. One can also imagine a microdevice with more optical handles than strictly necessary, where the user switches between the handles to provide good control regardless of orientation.

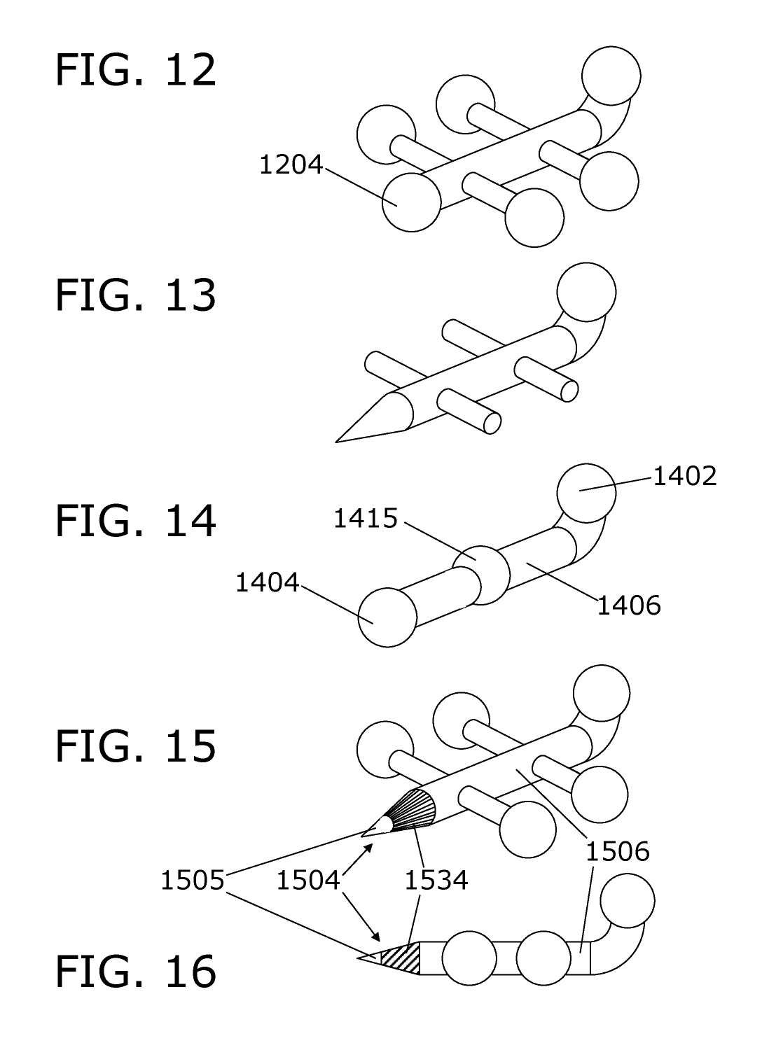

FIG. 12 is similar to FIG. 1 except that the EMR out-coupling element 1204 in the embodiment of the present figure has a round shape. In the present embodiment the EMR out-coupling element 1204 has a spherical shape, but other round shapes such paraboloidal, hyperboloidal or ellipsoidal are also considered to be encompassed by the present invention. The EMR out-coupling element may thus act as a lens. An advantage of this may be that the light out-coupling element may serve as an output element for shaping the EMR emitted from the first EMR emitting unit.

FIG. 13 is similar to FIG. 1 except that the linking structures are functioning as optical handles in the present embodiment.

FIG. 14 is similar to FIG. 1 except that the EMR out-coupling element in the embodiment of the present figure has a round shape and that the linking structures with their optical handles have been removed, and instead an optical handle 1415 has been placed directly around the light guiding element 1406. In the present embodiment, the spherical EMR in-coupling element 1402 and the spherical EMR out-coupling element 1404 also each function as an optical handle.

FIGS. 15-16 show respectively a perspective view and a side view similar to FIGS. 1-2. In FIGS. 15-16 the conical light out-coupling element 1504 is partially coated with a non-transparent coating 1534, where only the tip 1505 of the conical structure is left uncoated. An advantage of this may be that the EMR propagating through the light guiding element 1506 in a direction towards the conical out-coupling element 1504 may be confined spatially beyond the diffraction limit. A similar principle is used in Scanning Near Field Optical Microscopes (SNOMs) where a sub-wavelength aperture (which in the present embodiment corresponds to the small aperture in the coating 1534 in the end with the tip 1505) enables imaging or probing areas smaller than the diffraction limit. The present embodiment may thus be advantageous for using probing an area with EMR, where the area is smaller than what would have been possible without the coating 1534. In a particular embodiment, the light guiding element 1506 and the conical light out-coupling element 1504 may be of a fractral fibre structure where the internal structure of the conical out-coupling element scales with the outer diameter. This may be advantageous for further confining the propagating mode spatially. The principle of fractral fibres is described in the scientific article “A fractal-based fibre for ultra-high throughput optical probes”, S. T. Huntington et al., Optics Express, 5 Mar. 2007, Vol. 15, No. 5, 2468, which reference is hereby incorporated in entirety by reference. It is also encompassed by the invention that the light guiding element 1506 has a square-core optical fiber. Square-core optical fibers are described in “Square fibers solve multiple application challenges”, Franz Schberts et al., Photonics Spectra, Vol. 45, 2, p. 38-41, which reference is hereby incorporated in entirety by reference.

It is also encompassed by the invention to use other means for confining the propagating mode spatially beyond the diffraction limit, for example by using plasmonics as is described in the scientific article “Plasmonics beyond the diffraction limit”, by D. K. Gramotnev and S. I. Bozhevolnyi, Nature Photonics 4, 83-91, 2010, which is hereby incorporated in entirety by reference, and particular attention is drawn to the section entitled “Plasmon nanofocusing” p. 85-86.

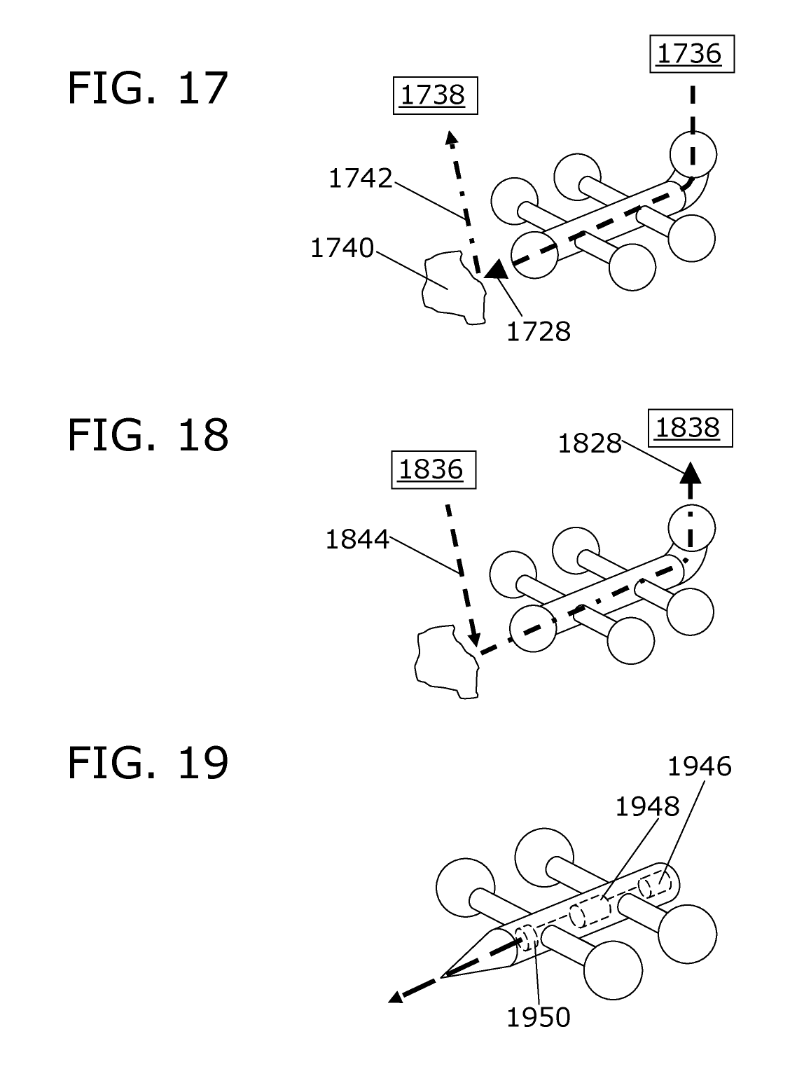

FIG. 17 shows an application of an embodiment of the microdevice. A light source 1736 provides light which is received by the light in-coupling element of the microdevice and emitted through the light out-coupling element as emitted light 1728. The emitted light is focused onto an associated object, e.g., a biological cell. In the present embodiment, the light out-coupling element confines the propagating mode spatially below the diffraction limit so as to probe only a very small area on the associated object 1740. The associated object receives the emitted light 1728 and in response re-emits light 1742 which is received by a detector 1738 in the far field. However, since only a small, well defined area on the associated object is probed, the light 1742 received by the detector comprises valuable information regarding this small area.

FIG. 18 shows an application of an embodiment of the microdevice. A light source 1836 provides light which is incident on an associated object 1840, e.g., a biological cell. The associated object receives the emitted light 1844 and in response re-emits light which is received by an in-coupling element of the microdevice. The in-coupling element is configured to only receive light from a small area on the associated device when placed within a short distance from the associated device, such as realized by a small aperture analogue to the aperture of SNOMs. The microdevice re-emits the received light as emitted light 1828, and the emitted light is received by detector 1838. Since only light from a small area on the associated object is collected, the light received by the detector 1838 comprises valuable information regarding this small area.

It is noticed that the microdevice in each of FIGS. 17-18 may be similar to each other, only the method of operating is different in that case. FIGS. 17-18 thus illustrates the bi-directionality of the microdevice and shows that the microdevice may both be used for emitting light onto an associated object and for collecting light emitted from an associated object.

FIG. 19 shows an embodiment which features an emitter. More particularly, the present embodiment features a communication module 1946, such as a radio communication module, a power source 1948, such as a battery, and an emitter 1950, such as a LASER unit. In a particular embodiment, the emitter comprises a electrically pumped photonic-crystal laser such as described in the reference “Ultralow-threshold electrically pumped quantum-dot photonic-crystal nanocavity laser”, B. Ellis et al., Nature Photonics, 5, 297-300, 2011, which is hereby incorporated in entirety by reference. In an alternative embodiment, the emitter is a fluorophore which may re-emit light upon excitation with light. In an alternative embodiment, the power source 1948 may include a unit capable of wirelessly receiving energy, such as energy transmitted via electromagnetic fields, such as employing the electrodynamic induction method (such as is known from passive RFID devices, such as by implementing an LC circuit), such as employing the electrostatic induction method (also known as the Tesla effect), such as by employing EMR (such as microwaves, such as light, such as LASER light), e.g., in combination with a photovoltaic element. A possible advantage of having a power source capable of receiving energy wirelessly may be that the microdevice will then be able to be powered without the need for wires or units for storing energy.

FIG. 20 shows a simulation of the light intensity during light guiding through a microdevice similar to the microdevice shown in FIGS. 1-5, modelled using the finite difference time domain method. The orientation of the microdevice in FIG. 20 is the same as in FIGS. 3-4. It is noticed, that the simulation explains the distribution of light intensity seen in the experimental data as observed in FIG. 4, and thus goes to show that the principles underlying the behaviour of the light in the microdevice are well understood by the present inventors. It is furthermore noticed, that it is encompassed by the present invention to apply a coating on the surface of the microdevice, or to modify the refractive index of the microdevice, or to modify the shape of the microdevice (e.g., using standard, well-known optimization schemes) such as to optimize the structure, e.g., in order to minimize leakage of light through the sides of the microdevice.

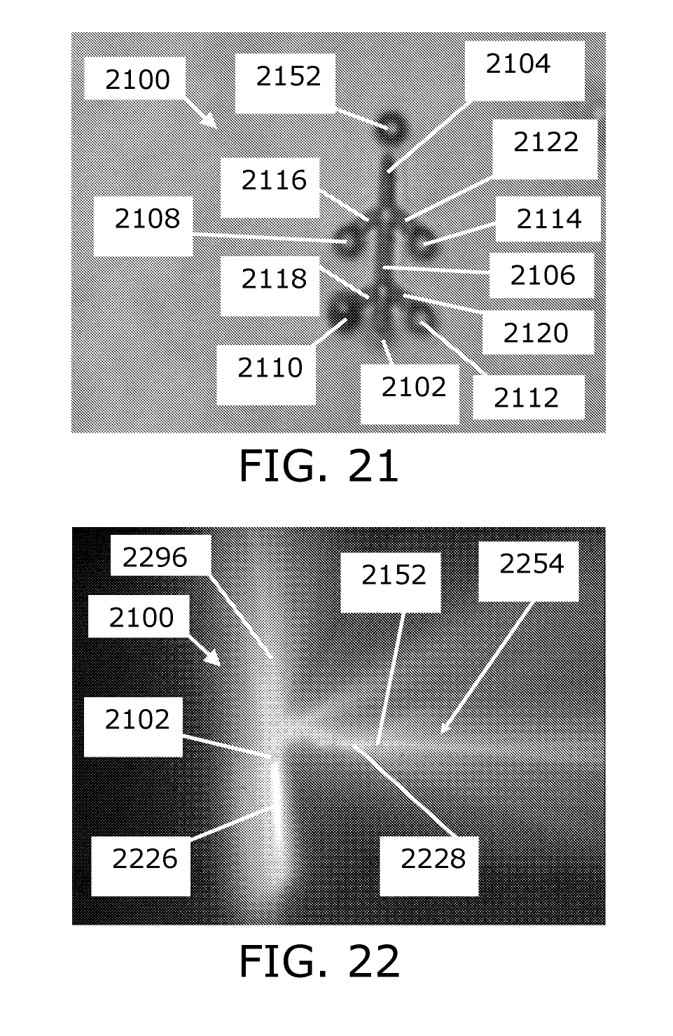

FIGS. 21-22 show experimental data in the form of images of an embodiment of the microdevice.

FIG. 21 shows a microdevice 2100 which is similar to the embodiment shown in FIG. 6 (notice that the microdevice in FIG. 6 points to the left while the microdevice in FIG. 21 points upwards). The microdevice in FIG. 21 is shown in a bottomview, i.e., the light guiding element 2106, the linking structures 2116, 2118, 2120, 2122, the optical handles 2108, 2110, 2112, 2114, and the light out-coupling element 2104 are all in the plane of the paper, which is hereafter referred to as the plane of the microdevice, while the light in-coupling 2102 element is on the other side of the plane of the microdevice with respect to the observer. In the plane of the microdevice is also seen a spherical bead 2152, which is optically trapped, just in front (i.e., ‘above’—in the picture) of the microdevice. The spherical bead 2152 may act as an output element for shaping the EMR emitted from the first EMR emitting unit.

FIG. 22 shows the microdevice 2100 of FIG. 21, however, it is noticed that the microdevice is reoriented with respect to the view in FIG. 21. In FIG. 22 the microdevice is shown in a side view, corresponding to the view in FIG. 2, except that the microdevice is rotated 180 degrees around an axis orthogonal to the plane of the paper, i.e., the microdevice in FIG. 21 has its light-out coupling element 2204 pointing to the right, and the light in-coupling element 2202 in the left end of the microdevice and pointing downwards. FIG. 22 furthermore features the spherical bead 2152 incoming light 2226 and emitted light 2228. FIG. 22 shows that the emitted light 2228 is shaped by the optically trapped spherical bead 2152, and it can be seen that the light is focused at a point 2254 in front of the microdevice. Notice that the EMR transmitted towards the EMR in-coupling element which is not collected by the incoming element (as opposed to the in-coupled incoming EMR), may be EMR 2296 which misses the in-coupling element (such as being in front of or behind in a direction orthogonal to the plane of the paper) or may propagate through the device completely.

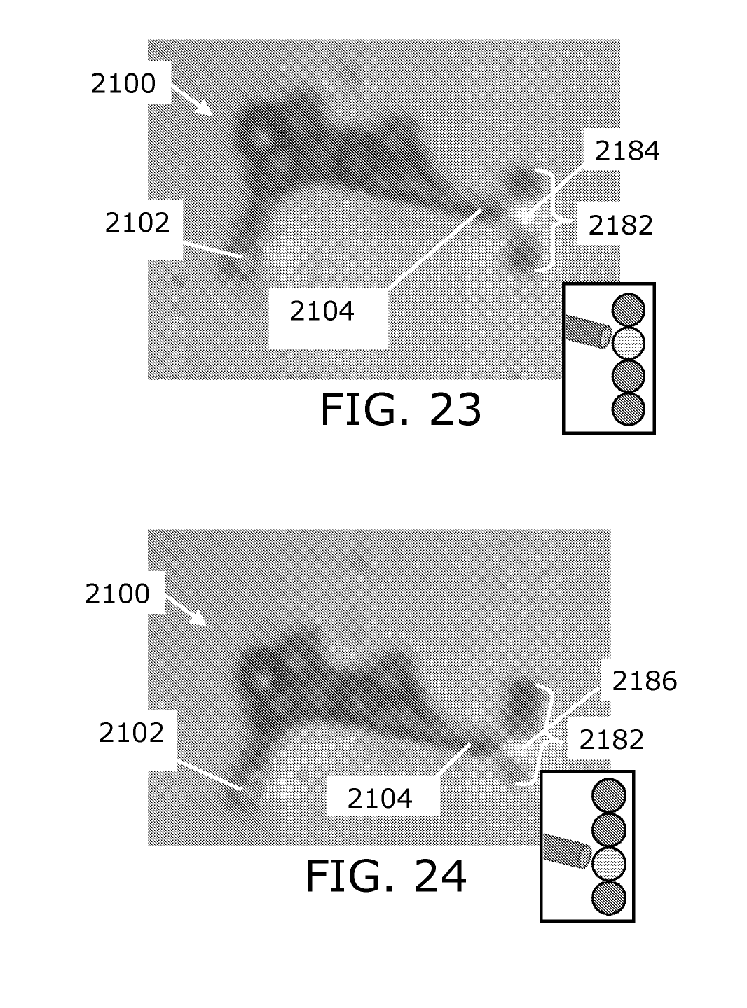

FIGS. 23-25 show light coupling and optical manipulation experiments.

FIGS. 23-24 are snapshots showing selective fluorescence excitation of a selected bead from a group of beads 2182, where the group of beads is a vertical column of 4 beads placed in a row being adjacent to each other. The selective fluorescence excitation is carried out using a micro device similar to the micro device schematically illustrated in FIGS. 1-2 and imaged in FIGS. 21-22.

FIG. 23 shows that selective illumination of the second bead 2184 from the top of the group of beads 2182, where the selective illumination is made with light coupled in through the light in-coupling element 2102 of the micro device 2100 and emitted via the light out-coupling element 2104. The inset schematically illustrates that only the second bead from the top is excited.

FIG. 24 correspondingly shows selective illumination of the third bead 2186 from the top of the group of beads 2182. The inset schematically illustrates that only the third bead from the top is excited.

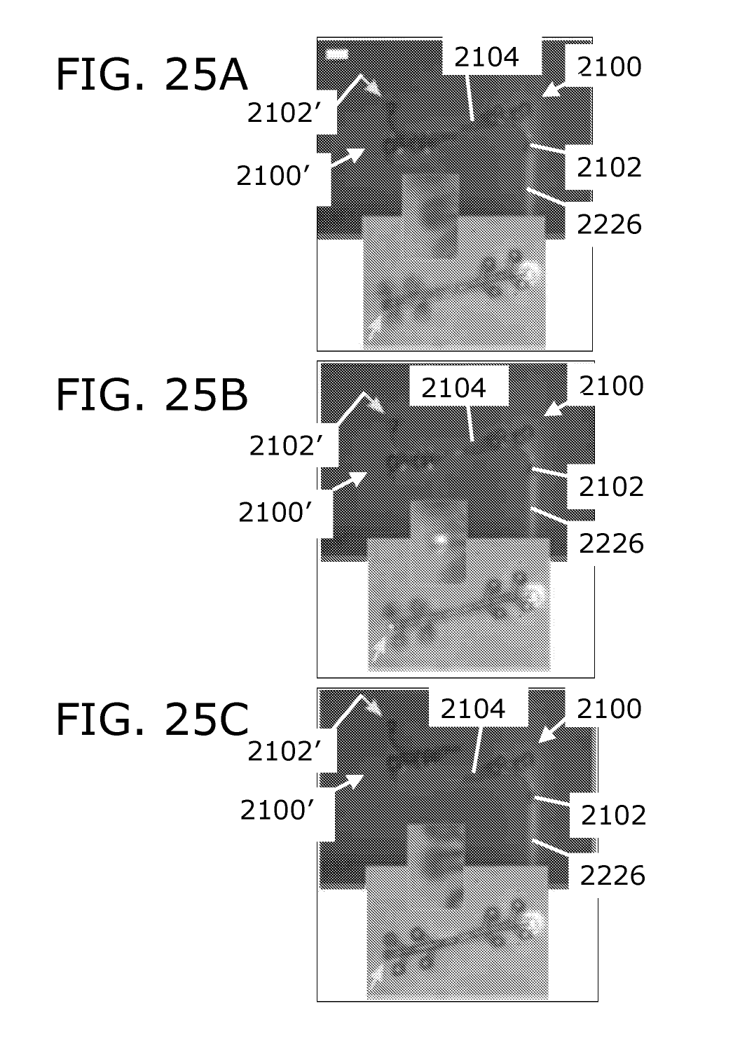

FIGS. 25A-C show experimental snapshots using reversed light coupling: An optically trapped micro device 2100 creates a localized field in front of the light out-coupling element 2104 by means of incoming targeting light 2226 which is coupled into the micro device via light in-coupling element 2102 and a second trapped micro device 2101′ (which is similar micro device 2100 except for a 180 degrees rotation around an axis orthogonal to the plane of the paper) which is manipulated, which in the present case means moved upwards, so as to scan the local field; the reverse-coupled light is visible from a top microscope, as is evident from the lower insets in each of FIGS. 25A-C and in particular the lower inset of FIG. 25B where a bright dot can be observed (as indicated by the arrow in the lower insert of FIG. 25B, which is enlarged in the middle inset). The bright dot corresponds to light which is emitted from the light out-coupling element 2104 of micro device 2100 and collected by a corresponding element on micro device 2100′ and subsequently emitted from the light in-coupling element 2102′ which in this case is emitting light. The scalebar is 10 micron. The middle inset in each of FIGS. 25A-C shows a close-up of the light in-coupling element 2102′ (which here function as an element for light out-coupling) also shown in the lower inset.

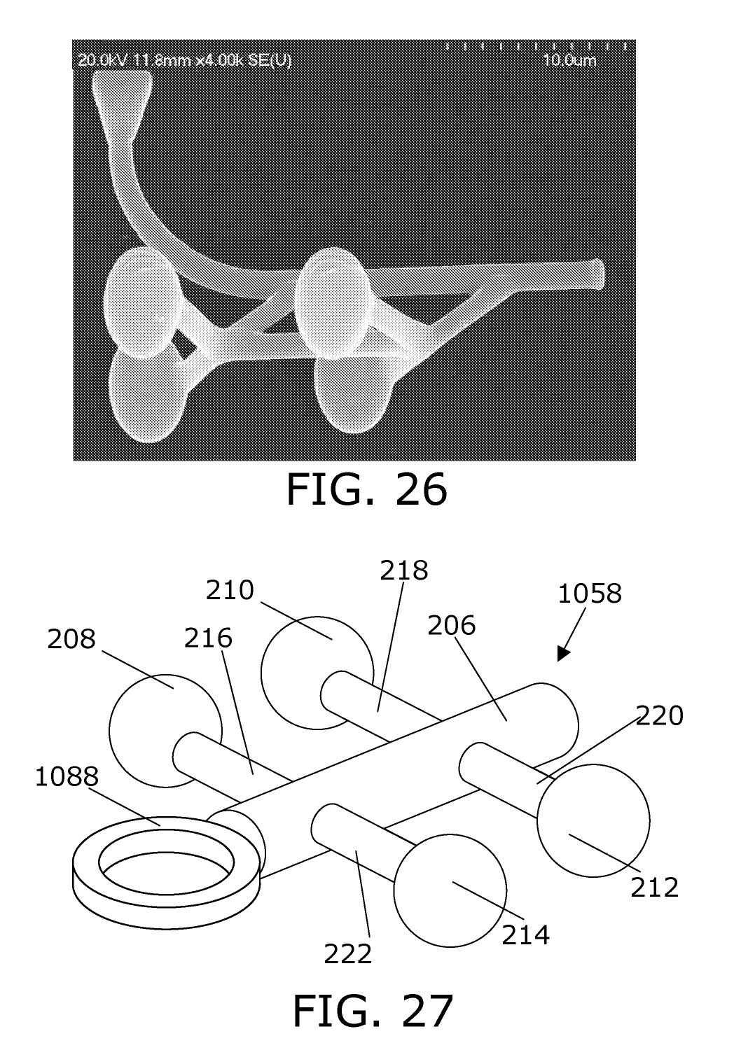

FIG. 26 shows a SEM image of a representative two-photon polymerized structure being a bent waveguide (bending radius R being approximately 8 micron; width being approximately 1.5 micron) sitting atop a supporting structure having spheroidal handles for optical trapping; the waveguide is connected via reverse-angled rods for minimal light-coupling loss via the support structure.

FIG. 27 shows another type of micro device 1058 similar to the micro devices depicted in FIGS. 1-2, except that the light in-coupling element 202 and the bend part 324 of the light guiding element is not present in the micro device of FIG. 27. Furthermore, a light out-coupling element 204 has been replaced with a holding means 1088 which in the present embodiment is a ring-shaped element. The advantage of having a holding means may be that it enables holding and manipulating other objects, such as spherical beads which may be applicable for use as optical elements. For example, a spherical bead which may be provided at a relatively low cost or effort, may in this way be collected and uses as an lens which can be brought relatively close to an object under examination.

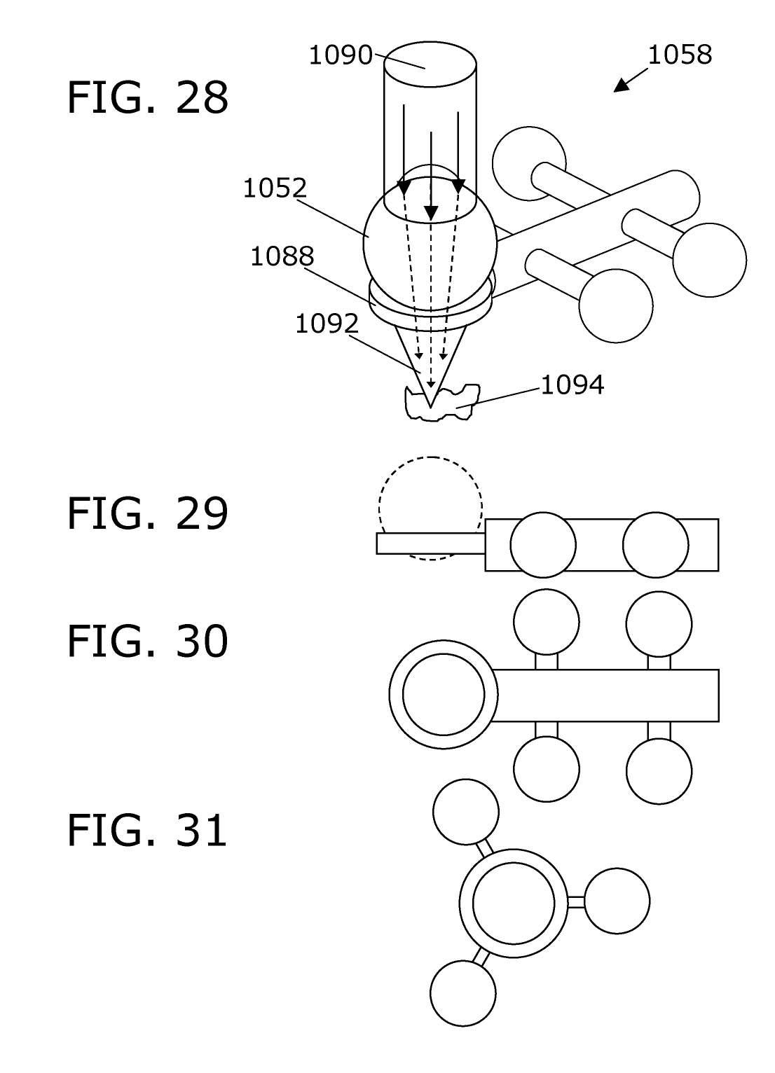

FIG. 28 is an illustration of the micro device 1058 of FIG. 27 which is here shown with a spherical bead 1052 in the holding means 1088. Incoming light 1090 is collected by the spherical bead, which now works as a lens element, and emitted light 1092 is focused on an object 1094 under examination.

FIG. 29 is a side view of micro device 1058.

FIG. 30 is a top view of micro device 1058.

FIG. 31 is a top view of an alternative embodiment of a micro device with holding means.

The basic idea proposed in FIGS. 27-31, is that optically manipulated micro devices, such as micro devices 1058, are designed with a holding means 1088, such as a mechanical tip-shape so that they can “pick up” and hold spherical objects which may function as ball lenses of different sizes (e.g. glass or polymer beads of different sizes) and act as 6 degrees of freedom (DOF) manipulated magnifying glasses on the submicron-scale. The ball lenses (beads) can simply be catapulted by beams and then each appropriate tool will be optically positioned to grip a bead when it slowly falls down similar to an oversize basketball landing in the basket net in slow motion. The ball lenses can be used bi-directionally to both focus independent light and capture and relay radiated light from a specimen.

A further generalization of the basic idea involves combining with micro devices with light couplers (such as light in-coupling element 202 of the embodiments depicted in FIGS. 1-2) so the reconfigurable ball lenses can be used from both top and side simultaneously. There is a host of variations on this basic concept.

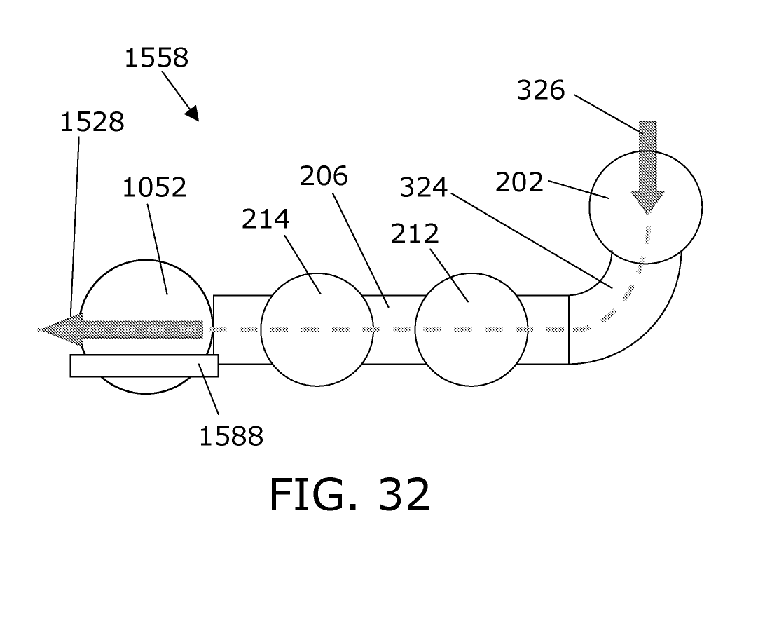

FIG. 32 shows a side view of another type of micro device 1558 similar to the micro devices depicted in FIGS. 27-31, except that the light in-coupling element 202 and the bend part 324 of the light guiding element is present in the micro device of FIG. 32. With the embodiment of FIG. 32, incoming light targeting 326 is guided through the micro device 1558 and collected by the spherical bead 1588, which now works as a lens element, and emitted light 1528 may be focused on any nearby object.

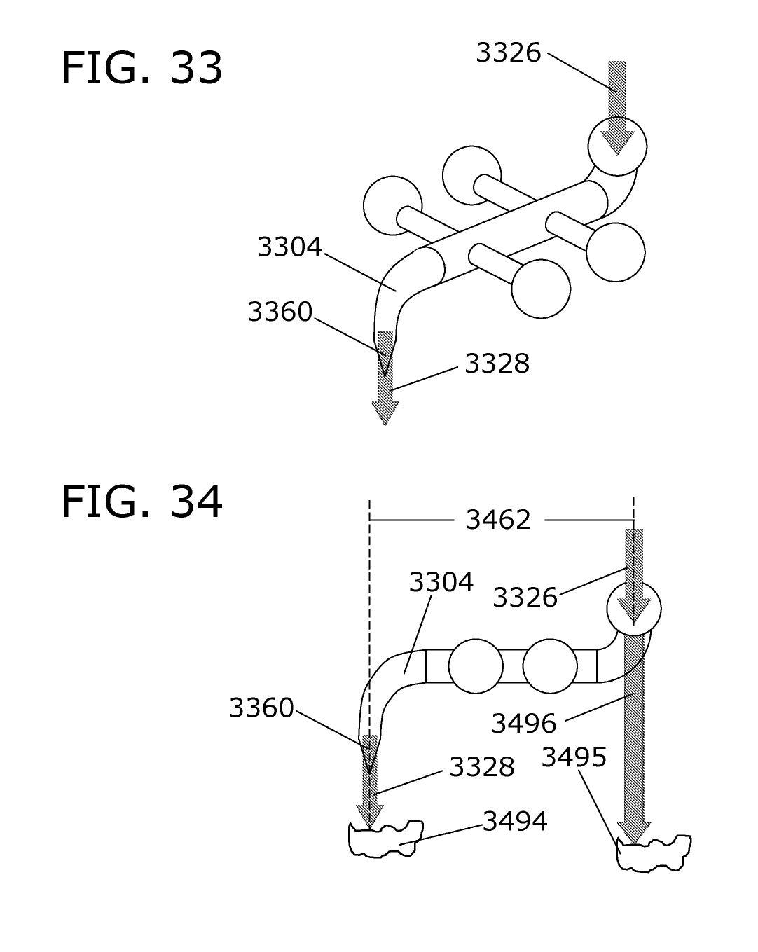

FIG. 33 is a perspective view similar to FIG. 1 except that the EMR out-coupling element 3304 in the embodiment of the present figure is arranged so that the EMR out-coupling element 3304 may emit EMR, such as emitted EMR 3328, being non-coaxial with the incoming electromagnetic radiation 3326.

FIG. 34 shows a side view of the embodiment depicted in FIG. 33.

In the embodiment depicted in FIGS. 33-34, the EMR out-coupling element 3304 is spatially displaced with respect to the EMR in-coupling element 3326 along a direction being orthogonal to the direction of the incoming EMR 3326, by a distance 3462, so that while the incoming EMR 3326 and emitted EMR 3328 may be parallel, they are still not coaxial. A possible advantage of this may be that the EMR transmitted towards the EMR in-coupling element which is not collected by the incoming element, may reduce the signal to noise ratio from an object 3495 placed on an axis coaxially with the incoming EMR because this EMR may contribute to a large background EMR. The EMR transmitted towards the EMR in-coupling element which is not collected by the incoming element, may be EMR 3496 which simply misses the in-coupling element (such as being in front of or behind in a direction orthogonal to the plane of the paper) or may propagate through the device completely. The object 3494 may be examined with higher signal to noise ratio, since there is less background EMR. In the present embodiment the EMR out-coupling element 3304 has a conically shape at the end 3360, but other round shapes such as spherical, paraboloidal, hyperboloidal or ellipsoidal are also considered to be encompassed by the present invention. The EMR out-coupling element may thus act as a lens.

In an exemplary set of embodiments E1-E15, there is provided:

E1. A microdevice (100) for emitting electromagnetic radiation, the microdevice comprising
a first electromagnetic radiation emitting unit (102, 104, 106) arranged to emit electromagnetic radiation,
means (108,110,112,114) for enabling simultaneous non-contact spatial control over the microdevice (100) in terms of:
   translational movement in three dimensions, and
   rotational movement around at least two axes,
      wherein the means for enabling non-contact spatial control over the microdevice are arranged for being spatially controlled by forces applied by electromagnetic radiation, and wherein the first electromagnetic radiation emitting unit and the means for enabling spatial control over the microdevice are structurally linked.

E2. A microdevice (100) for emitting electromagnetic radiation according to embodiment E1, comprising
means (108,110,112,114) for enabling simultaneous non-contact spatial control over the microdevice in terms of:
   translational movement in three dimensions, and
   rotational movement around at least three axes.

E3. A microdevice (100) for emitting electromagnetic radiation according to embodiment E1, wherein the means (108,110,112,114) for enabling spatial control over the microdevice comprise at least one electromagnetic radiation controllable handle.

E4. A microdevice (100) for emitting electromagnetic radiation according to embodiment E1, wherein the microdevice further comprises an emitter (1950), the emitter being arranged for emitting electromagnetic radiation.

E4B. A microdevice (100) for emitting electromagnetic radiation according to embodiment 4, wherein the emitter being arranged for emitting electromagnetic radiation within the visible range of the electromagnetic spectrum, such as within 380-750 nm.

E5. A microdevice (100) for emitting electromagnetic radiation according to embodiment E1, the microdevice further comprising:
an output element (104) for shaping the electromagnetic radiation emitted from the first electromagnetic radiation emitting unit.

E6. A microdevice (100) for emitting electromagnetic radiation according to embodiment E1, wherein the largest dimension of the microdevice is less than 1 millimetre.

E7. A microdevice (100) for emitting electromagnetic radiation according to embodiment E1, wherein the first electromagnetic radiation emitting unit and the means (108,110,112,114) for enabling spatial control over the microdevice are spatially separated from each other.

E8. A microdevice (100) for emitting electromagnetic radiation according to embodiment E1, the first electromagnetic radiation emitting unit comprising:
an electromagnetic radiation in-coupling element (102) arranged to receive incoming electromagnetic radiation, such as a plurality of electromagnetic radiation in-coupling elements,
an electromagnetic radiation out-coupling (104) element being structurally linked to the electromagnetic radiation in-coupling element and the electromagnetic radiation out-coupling element being arranged to emit electromagnetic radiation in response to said incoming electromagnetic radiation, such as a plurality of electromagnetic radiation out-coupling elements.

E9. A microdevice (100) for emitting electromagnetic radiation according to embodiment E1, wherein the microdevice comprises an electromagnetic radiation guiding element (106).

E10. A microdevice (100) for emitting electromagnetic radiation according to embodiment E8, wherein the electromagnetic radiation in-coupling element (102) is arranged to receive incoming electromagnetic radiation having a first direction and the electromagnetic radiation out-coupling element (104) is arranged to emit electromagnetic radiation having a second direction where the first direction and the second direction are substantially non-parallel, such as an angle between the first and second direction is at least 10 degrees, such as at least 20 degrees, such as at least 30 degrees, such as at least 45 degrees, such as at least 60 degrees, such as at least 80 degrees, such as substantially 90 degrees, such as substantially right-angled, such as right-angled.

E10B1. A microdevice for emitting electromagnetic radiation according to embodiment E8, wherein the electromagnetic radiation in-coupling element is arranged to receive incoming electromagnetic radiation having a first direction and the electromagnetic radiation out-coupling element is arranged to emit electromagnetic radiation having a second direction where the electromagnetic radiation out-coupling element is spatially displaced with respect to the electromagnetic radiation in-coupling element along a direction being orthogonal to the first direction.

E10B2. A microdevice (100) for emitting electromagnetic radiation according to embodiment E10B1, wherein the first direction and the second direction are substantially parallel, such as angle between the first direction and the second direction being within 10 degrees, such as within 5 degrees, such as within 2 degrees, such as within 1 degree, such as parallel.

E11. A microdevice (100) for emitting electromagnetic radiation according to embodiment E1, wherein the electromagnetic radiation out-coupling (104) element is arranged to confine the propagating mode spatially below the diffraction limit.

E12. A system for emitting electromagnetic radiation onto an associated object, the system comprising:
a microdevice (100) for emitting electromagnetic radiation according to embodiment E1,
a second electromagnetic radiation emitting unit being adapted to generate the electromagnetic radiation for spatially controlling the microdevice according to embodiment E1.

E13. A method for emitting electromagnetic radiation, the method including:
spatially controlling the microdevice (100) of embodiment E1 by applying electromagnetic radiation within a volume comprising the microdevice of embodiment E1,
emitting electromagnetic radiation from the microdevice of embodiment E1.

E14. A method according to embodiment E13, wherein the spatial controlling of the microdevice (100) of embodiment E1 by applying electromagnetic radiation, and the emitting of electromagnetic radiation from the microdevice of embodiment E1 is taking place simultaneously.

E15. A method according to embodiment E13, the method further comprising
the microdevice (100) of embodiment E1 receiving electromagnetic radiation, and
the microdevice of embodiment E1 emitting electromagnetic radiation in response to said receiving electromagnetic radiation.

To sum up, the present invention relates to a microdevice for emitting electromagnetic radiation, the microdevice being adapted so as to be controllable by electromagnetic radiation, such as light. The microdevice comprises a first electromagnetic radiation emitting unit arranged to emit electromagnetic radiation 1728, so as to be able to irradiate electromagnetic radiation onto a structure of interest 1740. The microdevice further comprising means for enabling non-contact spatial control over the microdevice in terms of translational movement in three dimensions, and rotational movement around at least two axes. The present invention thus provides an instrument which enables controlled irradiation of light onto very well defined areas on the nano-scale of objects of interest. Furthermore, the device enables receipt of light and may thus work as an optically controlled microendoscope.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A microdevice for emitting electromagnetic radiation, the microdevice comprising:
a first electromagnetic radiation emitting unit arranged to emit electromagnetic radiation,
a means for enabling simultaneous non-contact spatial control over the microdevice in terms of:
translational movement in three dimensions, and
rotational movement around at least two axes,
wherein the means for enabling non-contact spatial control over the microdevice are arranged for being spatially controlled by forces applied by electromagnetic radiation, and wherein the first electromagnetic radiation emitting unit and the means for enabling spatial control over the microdevice are structurally linked,
wherein the first electromagnetic radiation emitting unit comprises:
an electromagnetic radiation in-coupling element arranged to receive incoming electromagnetic radiation,
an electromagnetic radiation out-coupling element being structurally linked to the electromagnetic radiation in-coupling element and the electromagnetic radiation out-coupling element being arranged to emit electromagnetic radiation in response to said incoming electromagnetic radiation, and
wherein the electromagnetic radiation in-coupling element is arranged to receive incoming electromagnetic radiation having a first direction and the electromagnetic radiation out-coupling element is arranged to emit electromagnetic radiation having a second direction where the first direction and the second direction are non-parallel,
or
wherein the electromagnetic radiation in-coupling element is arranged to receive incoming electromagnetic radiation having a first direction and the electromagnetic radiation out-coupling element is arranged to emit electromagnetic radiation having a second direction where the electromagnetic radiation out-coupling element is spatially displaced with respect to the electromagnetic radiation in-coupling element along a direction being orthogonal to the first direction, and where the first direction and the second direction are parallel.

2-15. (canceled)

16. The microdevice for emitting electromagnetic radiation according to claim 1, wherein the electromagnetic radiation in-coupling element is arranged to receive incoming electromagnetic radiation having a first direction and the electromagnetic radiation out-coupling element is arranged to emit electromagnetic radiation having a second direction where the first direction and the second direction are non-parallel, where the electromagnetic radiation out-coupling element is spatially displaced with respect to the electromagnetic radiation in-coupling element along a direction being orthogonal to the first direction.

17. The microdevice for emitting electromagnetic radiation according to claim 1, comprising
a means for enabling simultaneous non-contact spatial control over the microdevice in terms of:
translational movement in three dimensions, and
rotational movement around at least three axes.

18. The microdevice for emitting electromagnetic radiation according to claim 1, wherein the means for enabling spatial control over the microdevice comprises at least one electromagnetic radiation controllable handle.

19. The microdevice for emitting electromagnetic radiation according to claim 1, wherein the microdevice further comprises an emitter, the emitter being arranged for emitting electromagnetic radiation.

20. The microdevice for emitting electromagnetic radiation according to claim 19, wherein the emitter is arranged for emitting electromagnetic radiation within the visible range of the electromagnetic spectrum.

21. The microdevice for emitting electromagnetic radiation according to claim 1, the microdevice further comprising:
an output element for shaping the electromagnetic radiation emitted from the first electromagnetic radiation emitting unit.

22. The microdevice for emitting electromagnetic radiation according to claim 1, wherein the largest dimension of the microdevice is less than 1 millimetre.

23. The microdevice for emitting electromagnetic radiation according to claim 1, wherein the first electromagnetic radiation emitting unit and the means for enabling spatial control over the microdevice are spatially separated from each other.

24. The microdevice for emitting electromagnetic radiation according to claim 1, wherein the microdevice comprises an electromagnetic radiation guiding element.

25. The microdevice for emitting electromagnetic radiation according to claim 1, wherein the electromagnetic radiation out-coupling element is arranged to confine the propagating mode spatially below the diffraction limit.

26. A system for emitting electromagnetic radiation onto an associated object, the system comprising:
a microdevice for emitting electromagnetic radiation according to claim 1, and
a second electromagnetic radiation emitting unit being adapted to generate the electromagnetic radiation for spatially controlling the microdevice according to claim 1.

27. A method for emitting electromagnetic radiation, the method comprising:
spatially controlling the microdevice of claim 1 by applying electromagnetic radiation within a volume comprising the microdevice of claim 1, and
emitting electromagnetic radiation from the microdevice of claim 1.

28. The method according to claim 27, wherein the spatial controlling of the microdevice of claim 1 is performed by applying electromagnetic radiation, and the emitting of electromagnetic radiation from the microdevice of claim 1 is taking place simultaneously.

29. A method according to claim 27, the method further comprising:
receiving electromagnetic radiation with the microdevice of claim 1, and
emitting electromagnetic radiation from the microdevice of claim 1 in response to said receiving electromagnetic radiation.
